(19) United States
(12) Patent Application Publication
(10) Pub. No.: US 2025/0010766 A1
(43) Pub. Date: Jan. 9, 2025

(54) VEHICLE SEAT

(71) Applicant: TOYOTA BOSHOKU KABUSHIKI KAISHA, Aichi (JP)

(72) Inventors: Ryoya TATEMATSU, Nissin-shi (JP); Sho TERADA, Nagoya-shi (JP); Shunsuke TANAKA, Toyota-shi (JP)

(73) Assignee: TOYOTA BOSHOKU KABUSHIKI KAISHA, Aichi (JP)

(21) Appl. No.: 18/746,629

(22) Filed: Jun. 18, 2024

(30) Foreign Application Priority Data
Jul. 3, 2023 (JP) 2023-109320

(51) Int. Cl. B60N 2/20; B60N 2/22

(52) U.S. Cl. CPC B60N 2/20; B60N 2/22

(57) ABSTRACT

A vehicle seat includes: a recliner plate with a recliner attached thereto, the recliner plate being fixed to a cushion frame; a hinge pin configured to cause the recliner to perform a release operation; and a bushing forming a plain bearing that rotatably supports the hinge pin, and being fixed to the recliner plate. The bushing has a block shape with a through hole which the hinge pin passes through, and is directly fixed to the recliner plate.

### CROSS-REFERENCE TO RELATED APPLICATIONS

This application claims the benefit of Japanese Patent Application No. 2023-109320 filed on Jul. 3, 2023 with the Japan Patent Office, the entire disclosure of which is incorporated herein by reference.

### BACKGROUND

The present disclosure relates to a vehicle seat to be mounted in a vehicle.

In a vehicle seat described, for example, in Japanese Unexamined Patent Application Publication No. 2018-30519, a hinge pin (4a) is rotatably supported by a hinge bracket (60) made of a press-formed plate material. The hinge bracket (60) is fixed to a recliner plate (3f) via a rotating operation member (50). Numerals in parentheses are reference numerals in Japanese Unexamined Patent Application Publication No. 2018-30519.

### SUMMARY

In the vehicle seat described in Japanese Unexamined Patent Application Publication No. 2018-30519, the hinge bracket and the rotating operation member for supporting the hinge pin are large in shape. Therefore, as the mass of components for supporting the hinge pin increases, a large space for arranging those components is required.

In view of the above point, the present disclosure discloses an example vehicle seat that can reduce the mass and size of components for supporting the hinge pin.

It is desirable that a vehicle seat configured to be mounted in a vehicle comprise, for example, at least one of the following elements.

Specifically, the elements include: a recliner plate with a recliner attached thereto, the recliner plate being fixed to a cushion frame; a hinge pin configured to cause the recliner to perform a release operation; a bushing forming a plain bearing that rotatably supports the hinge pin, and the bushing being fixed to the recliner plate. The bushing has a block shape with a through hole which the hinge pin passes through, and is directly fixed to the recliner plate.

The above configuration causes the hinge pin to be rotatably supported by the bushing in the present vehicle seat. Thus, the mass and size of the components for supporting the hinge pin can be reduced.

The present vehicle seat may be also configured as below.

Specifically, it is desirable that the vehicle seat comprises: a cable operation bracket coupled to an operation cable, the cable operation bracket being configured to be rotatable around a center axis of the hinge pin; and a flange provided on the hinge pin and protruding outward from the hinge pin, and that the cable operation bracket is interposed between the flange and the bushing in such a manner that the cable operation bracket is in sliding contact with the flange and the bushing.

The above configuration determines the position of the cable operation bracket in a direction of the center axis relative to the bushing. In other words, since the cable operation bracket comes into contact with the bushing, the position of the cable operation bracket in the direction of the center axis can be uniquely determined by external dimensions of the bushing. Accordingly, in the present vehicle seat, high positional accuracy of the cable operation bracket in the direction of the center axis can be easily achieved.

It is desirable that the vehicle seat comprises a cover member configured to inhibit the hinge pin from falling out of the through hole, and the cover member is fixed to the recliner plate, and arranged opposite to the cable operation bracket with the flange in between.

It is desirable that the cover member includes a cable stopper configured to catch an outer tube of the operation cable.

It is also desirable that the vehicle seat comprises an elastically deforming portion configured to apply an elastic force to the cable operation bracket, and the cover member includes a holder configured to hold the elastically deforming portion.

In addition, it is desirable that the vehicle seat comprises: a action portion provided in the elastically deforming portion and configured to contact the cable operation bracket to apply the elastic force to the cable operation bracket, the action portion having a linear shape and extending substantially parallel to the center axis; and a restrictor provided on the cover member and configured to contact the action portion to restrict the action portion from titling further when the action portion tilts beyond a specified range, and that the restrictor is out of alignment relative to the cable operation bracket in a direction of the center axis.

### BRIEF DESCRIPTION OF THE DRAWINGS

An example embodiment of the present disclosure will be described hereinafter with reference to the accompanying drawings, in which:

FIG. 1 is a view showing a vehicle seat;

FIG. 2 is a view showing a configuration around a hinge pin;

FIG. 3 is an exploded view around the hinge pin;

FIG. 4 is a view showing a bushing;

FIG. 5 is a sectional view showing a configuration around the hinge pin; and

FIG. 6 is view showing a configuration around the hinge pin.

### DETAILED DESCRIPTION OF EXEMPLARY EMBODIMENTS

Embodiments below show example embodiments belonging to the technical scope of the present disclosure. That is, invention-specifying matters and so on recited in the appended claims are not limited by specific configurations, structures, and the like indicated in the below-described embodiments.

The present embodiment is an example in which the present disclosure is applied to a seat to be mounted in a vehicle such as a car (hereinafter referred to as a “vehicle seat”). Arrows indicating directions, hatched lines, and so on shown in the drawings are provided for the purpose of easier understanding of mutual relationships between the drawings, shapes of members or portions, and so on.

Thus, the present vehicle seat is not limited by the directions shown in the drawings. The directions shown in the drawings are directions in a state where the vehicle seat according to the present embodiment is mounted in the car. The drawings with hatched lines do not necessarily indicate sectional views.

A member or portion described at least with a reference numeral is at least one in number except in a case of being accompanied by restrictive words such as “only one”. In other words, the member or portion may be two or more in number in a case of not being accompanied by the restrictive words such as “only one”. The vehicle seat shown in the present disclosure comprises at least one of components, such as members or portions described at least with reference numerals, and structural portions illustrated in the drawings.

### <1. Overview of Vehicle Seat>

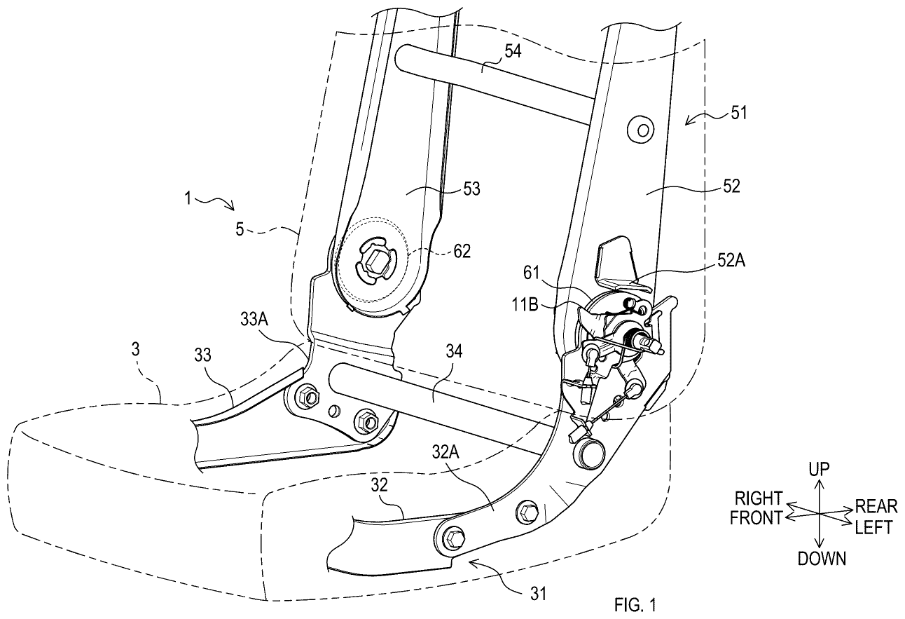

As shown in FIG. 1, a vehicle seat 1 comprises a seat cushion 3, a seatback 5, and so on. The seat cushion 3 supports the buttocks of an occupant of the vehicle seat 1. The seatback 5 supports the back of the occupant.

The seat cushion 3 includes a cushion frame 31, a cushion pad (not shown), and so on. The cushion frame 31 is included in a framework of the seat cushion 3. The cushion pad is an elastic member made of foamed urethane or the like. The cushion frame 31 of the present embodiment is a frame-shaped member that includes first and second cushion-side frames 32, 33, a coupling member 34, and so on. The first cushion-side frame 32 is arranged on a first end side of the seat cushion 3 in a seat-width direction and extends in a seat front-rear direction.

The second cushion-side frame 33 is arranged on a second end side of the seat cushion 3 in the seat-width direction and extends in the seat front-rear direction. The coupling member 34 extends in the seat-width direction and couples the first and second cushion-side frames 32, 33.

The seatback 5 includes a back frame 51, a cushion pad (not shown), and so on. The back frame 51 is included in a framework of the seatback 5. The cushion pad is an elastic member made of foamed urethane or the like.

The back frame 51 of the present embodiment is a frame-shaped member that includes first and second side frames 52, 53, at least one coupling member 54, and so on. The first side frame 52 is arranged on the first end side of the seat cushion 3 in the seat-width direction and extends in a substantially up-down direction.

The second side frame 53 is arranged on the second side of the seat cushion 3 in the seat-width direction and extends in the substantially up-down direction. The coupling member 54 extends in the seat-width direction and couples the first and second side frames 52, 53.

At portions where the cushion frame 31 and the back frame 51 are coupled, first and second recliner plates 32A, 33A, first and second recliners 61, 62, and so on are provided. The first recliner 61 is attached to the first recliner plate 32A. The first recliner plate 32A is fixed to the first cushion-side frame 32.

The second recliner 62 is attached to the second recliner plate 33A. The second recliner plate 33A is fixed to the second cushion-side frame 33. The first and second recliners 61, 62 are mechanisms for adjusting an angle of the back frame 51 relative to the cushion frame 31.

Specifically, each of the first and second recliners 61, 62 includes a ratchet with inner teeth, and a pawl with outer teeth configured to engage with the inner teeth. This configuration is similar to that of a recliner, for example, of Japanese Unexamined Patent Application Publication No. 2000-102440.

The first and second recliners 61, 62 of the present embodiment have a release function (also referred to as a fold-down function). The release function indicates a function to tilt the back frame 51 forward so that the seatback 5 approaches the seat cushion 3.

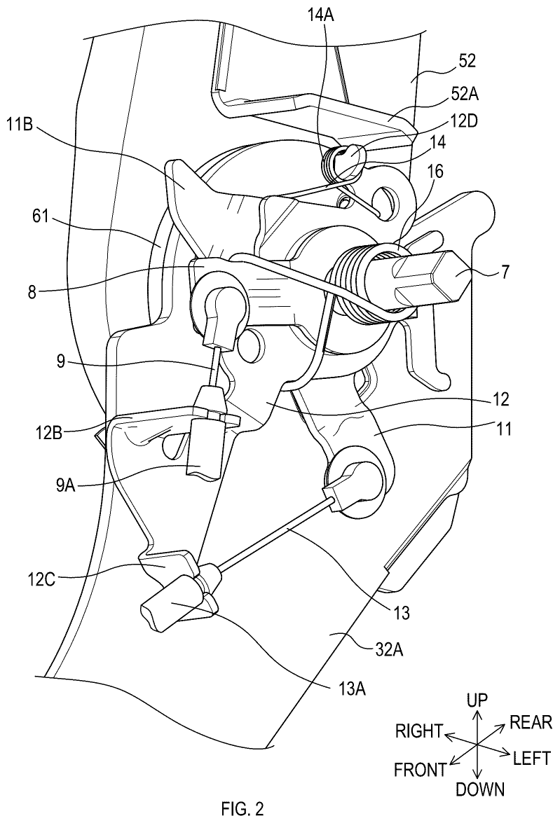

As components to implement the release function, the vehicle seat 1 of the present embodiment comprises a hinge pin 7, a release lever 8, an operation cable 9, an operation lever (not shown), and so on, as shown in FIG. 2.

The operation lever is an operating portion to be rotated by a user of the vehicle seat 1 when the release function is enabled. The hinge pin 7 is an axial member that rotates mechanically in conjunction with the rotation of the operation lever when the release function is enabled.

When the hinge pin 7 rotates, the first recliner 61 operates so as to tilt the back frame 51 forward (hereinafter, also referred to as a release operation). Specifically, when the hinge pin 7 rotates, engagement between the ratchet and the pawl of the first recliner 61 is released. Therefore, due to an elastic force of a spiral spring (not shown), the back frame 51 is tilted forward.

The release lever 8 is a lever that rotates integrally with the hinge pin 7. The operation cable 9 is a control cable coupled to the release lever 8. The operation cable 9 transmits the rotation of the hinge pin 7 to the second recliner 62 so as to cause the second recliner 62 to perform the release operation.

The operation lever is directly coupled to the hinge pin 7. Therefore, when the user operates the operation lever to rotate the operation lever, the hinge pin 7 rotates in conjunction with the operation lever. Accordingly, the first and second recliners 61, 62 perform the release operation in conjunction with the rotation operation of the operation lever.

<2. Supporting Structure, Etc. Of Hinge Pin>

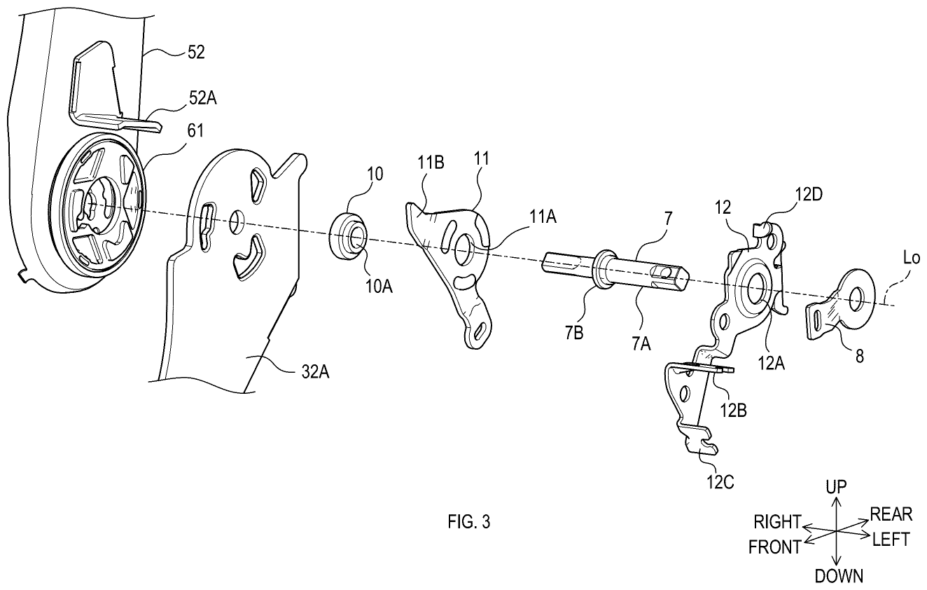

As shown in FIG. 3, a bushing 10, a cable operation bracket 11, a cover member 12, and so on are provided around the hinge pin 7 and the first recliner 61. The first recliner plate 32A is welded and fixed to a first surface of the first recliner 61. A second surface of the first recliner 61 is welded and fixed to the first side frame 52.

### <Hinge Pin>

The hinge pin 7 includes a bar-shaped shaft 7A and a flange 7B. The flange 7B is a flange-shaped portion protruding outward from the shaft 7A. The flange 7B according to the present embodiment is a ring-shaped portion protruding around the entire circumference of the shaft 7A.

### <Bushing>

The bushing 10 is a member forming a plain bearing that rotatably supports the hinge pin 7. The bushing 10 is fixed to the first recliner plate 32A by a fixing method such as press fitting or welding (welding, in the present embodiment).

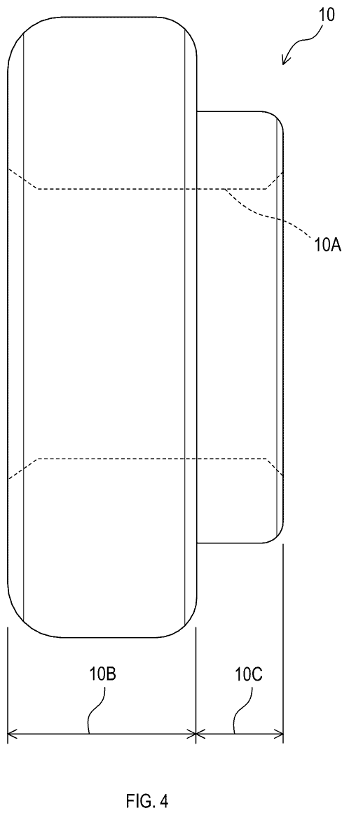

The bushing 10 is a block body with a through hole 10A which the hinge pin 7 passes through. The bushing 10 is directly welded and fixed to the first recliner plate 32A. Specifically, the bushing 10 includes a large diameter portion 10B and a small diameter portion 10C, as shown in FIG. 4.

The large diameter portion 10B is a portion with a larger outer diameter than the small diameter portion 10C. The bushing 10 is a one-piece product in which the large diameter portion 10B and the small diameter portion 10C are integrally formed (forged or cast, in the present embodiment) from metal.

### <Cable Operation Bracket>

As shown in FIG. 2, the cable operation bracket 11 is a cable operation lever to which the operation cable 13 is coupled. The cable operation bracket 11 is rotatable around a center axis Lo (see FIG. 3) of the hinge pin 7.

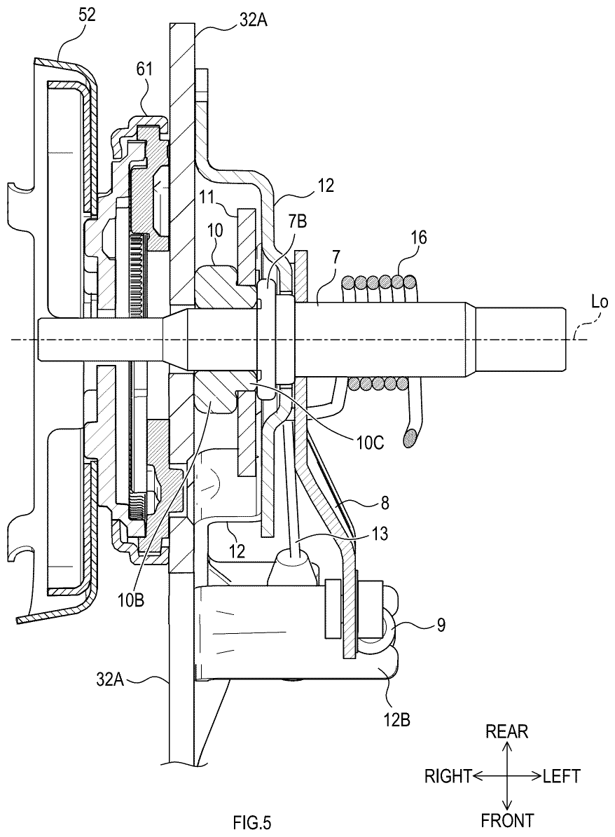

Specifically, as shown in FIG. 5, the cable operation bracket 11 is interposed between the flange 7B and the bushing 10 in such a manner that the cable operation bracket 11 is in sliding contact with the flange 7B and the bushing 10.

More specifically, the small diameter portion 10C of the bushing 10 fits into a shaft hole 11A (see FIG. 3) of the cable operation bracket 11 in such a manner that the small diameter portion 10C is in sliding contact with the shaft hole 11A. The large diameter portion 10B of the bushing 10 is arranged on a first side (left side in FIG. 5) of the cable operation bracket 11.

The flange 7B of the hinge pin 7 is arranged on a second side (right side in FIG. 5) of the cable operation bracket 11. Thus, the cable operation bracket 11 is interposed between the flange 7B and the bushing 10.

The cable operation bracket 11 pulls the operation cable 13 when the seatback 5 tilts and an abutting portion 52A (see FIG. 2) provided on the seatback 5 hits an abutment target portion 11B (see FIG. 2) of the cable operation bracket 11.

When the operation cable 13 is pulled, a lock device (not shown) that fixes a lower portion of a rear end side of the seat cushion 3 to a vehicle floor is released, and the vehicle seat 1 becomes rotatable (in other words, tumbleable) around a lower part of a front end side of the seat cushion 3.

### <Cover Member>

The cover member 12 is a member that inhibits the hinge pin 7 from falling out of the through hole 10A of the bushing 10. Specifically, the cover member 12 has a through hole 12A (see FIG. 3) which the hinge pin 7 passes through.

The through hole 12A has an inner diameter that is smaller than an outer diameter of the flange 7B. As shown in FIG. 5, the cover member 12 is arranged opposite to the cable operation bracket 11 with the flange 7B in between, and fixed to the first recliner plate 32A. The cover member 12 of the present embodiment is fixed to the first recliner plate 32A by welding.

As shown in FIG. 2, the cover member 12 includes first and second cable stoppers 12B, 12C. The first cable stopper 12B catches an outer tube 9A of the operation cable 9.

The second cable stopper 12C catches an outer tube 13A of the operation cable 13. Moreover, the cover member 12 includes a spring holder 12D that holds a spring 14 (in other words, an elastically deforming portion). The spring 14 applies an elastic force to the cable operation bracket 11.

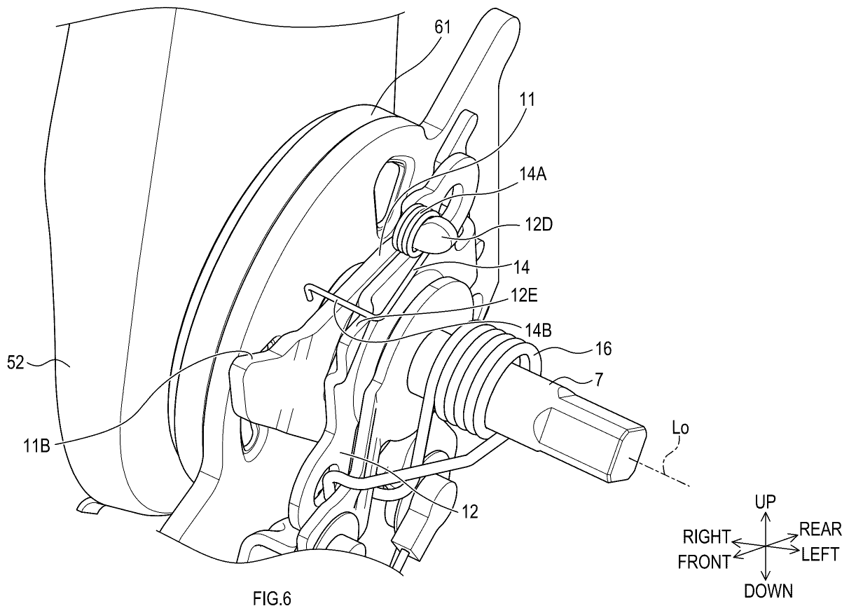

As shown in FIG. 6, the spring 14 is a torsion coil spring, which exerts an elastic force to rotate the cable operation bracket 11 in a direction to pull the operation cable 13. The spring holder 12D supports a coil 14A of the spring 14.

The spring 14 includes an action portion 14B. The action portion 14B is a linear portion that extends substantially parallel to the center axis Lo. The action portion 14B comes into contact with the cable operation bracket 11 and applies an elastic force to the cable operation bracket 11.

The cover member 12 includes a restrictor 12E. The restrictor 12E comes into contact with the action portion 14B to restrict the action portion 14B from tilting further when the action portion 14B tilts beyond a specified range.

Therefore, in a state shown in FIG. 6, that is, in a state where the seatback 5 is not tilted, a small gap (not shown) is provided between the restrictor 12E and the action portion 14B. When the action portion 14B tilts, the restrictor 12E comes into contact with the action portion 14B, and further tilting of the action portion 14B is restricted.

Moreover, the restrictor 12E is out of alignment relative to the cable operation bracket 11 in a direction of the center axis Lo. In other words, a part of the cable operation bracket 11 that is in contact with the action portion 14B and the restrictor 12E are separated in the direction of the center axis Lo.

The spring 16 applies an elastic force to the release lever 8. Thus, the release lever 8 is held at a position shown in FIG. 2 when an operation force is not applied to the operation lever. When the release lever 8 and the hinge pin 7 rotate from that position, the first and second recliners 61, 62 perform the release operation.

### <3. Characteristics of Vehicle Seat of Present Embodiment>

In the vehicle seat 1 of the present embodiment, the hinge pin 7 is rotatably supported by the bushing 10. This configuration makes it possible to reduce the mass and size of components for supporting the hinge pin 7 in the vehicle seat 1, as compared to the configuration described in Japanese Unexamined Patent Application Publication No. 2018-30519.

The cable operation bracket 11 is interposed between the flange 7B and the bushing 10 in such a manner that the cable operation bracket 11 is in sliding contact with the flange 7B and the bushing 10. This determines the position of the cable operation bracket 11 in the direction of the center axis Lo (hereinafter, simply referred to as “position”) relative to the bushing 10.

Specifically, since the cable operation bracket 11 comes into contact with the bushing 10, the position of the cable operation bracket 11 can be uniquely determined by external dimensions of the bushing 10. Accordingly, in the vehicle seat 1, high positional accuracy of the cable operation bracket 11 can be easily achieved.

The cover member 12 includes the second cable stopper 12C that catches the outer tube 13A of the operation cable 13, and the spring holder 12D that holds the spring 14. This reduces man-hours for attaching the second cable stopper 12C and the spring holder 12D to the cushion frame 31.

The restrictor 12E is provided which comes into contact with the action portion 14B to restrict the action portion 14B from tilting further when the action portion 14B tilts beyond a specified range. The restrictor 12E is out of alignment relative to the cable operation bracket 11 in the direction of the center axis Lo. This can, in advance, inhibit operation of the spring 14 from being obstructed.

### OTHER EMBODIMENTS

The bushing 10 of the aforementioned embodiment has a cylindrical shape with a stepped portion. However, the present disclosure is not limited thereto. Specifically, the bushing may be formed, for example, by a block body with a rectangular outer shape.

The bushing 10 of the aforementioned embodiment is made from metal. However, the present disclosure is not limited thereto. Specifically, the bushing may be, for example, made from hard resin such as POM.

The cable operation bracket 11 of the aforementioned embodiment operates the operation cable for releasing the lock device. However, the present disclosure is not limited thereto. Specifically, the cable operation bracket may, for example, operate other operation cables.

The cover member 12 of the aforementioned embodiment includes the second cable stopper 12C that catches the outer tube 13A of the operation cable 13, and the spring holder 12D that holds the spring 14. However, the present disclosure is not limited thereto.

In the aforementioned embodiment, the restrictor 12E is provided which is out of alignment relative to the cable operation bracket 11 in the direction of the center axis Lo. However, the present disclosure is not limited thereto. Specifically, in the present disclosure, for example, the restrictor 12E may be omitted, or the restrictor 12E may be proximate to the cable operation bracket 11.

In the aforementioned embodiment, the vehicle seat of the present disclosure is applied to a car. However, application of the vehicle seat is not limited thereto. Specifically, the vehicle seat may be used, for example, in vehicles such as for railroads, ships and boats, and aircrafts, or as a stationary seat such as in theaters and households.

Moreover, the present disclosure is not limited to the aforementioned embodiments, and may be implemented in any manner within the spirit of the disclosure described in the aforementioned embodiments. Accordingly, the present disclosure may include a configuration where at least two of the aforementioned embodiments are combined, or a configuration where some of the elements shown in the drawings or described with reference numerals in the aforementioned embodiments are omitted.

What is claimed is:

1. A vehicle seat configured to be mounted in a vehicle, the vehicle seat comprising:
a recliner plate with a recliner attached thereto, the recliner being fixed to a cushion frame;
a hinge pin configured to cause the recliner to perform a release operation; and
a bushing forming a plain bearing that rotatably supports the hinge pin, the bushing being fixed to the recliner plate,
the bushing having a block shape with a through hole which the hinge pin passes through, and the bushing being directly fixed to the recliner plate.

2. The vehicle seat according to claim 1, comprising:
a cable operation bracket to which an operation cable is coupled, the cable operation bracket being configured to be rotatable around a center axis of the hinge pin; and
a flange provided on the hinge pin, the flange protruding outward from the hinge pin, wherein
the cable operation bracket is interposed between the flange and the bushing in such a manner that the cable operation bracket is in sliding contact with the flange and the bushing.

3. The vehicle seat according to claim 2, comprising:
a cover member configured to inhibit the hinge pin from falling out of the through hole, the cover member being fixed to the recliner plate, wherein
the cover member is arranged opposite to the cable operation bracket with the flange in between.

4. The vehicle seat according to claim 3, wherein
the cover member includes a cable stopper configured to catch an outer tube of the operation cable.

5. The vehicle seat according to claim 4, comprising:
an elastically deforming portion configured to apply an elastic force to the cable operation bracket, wherein
the cover member includes a holder configured to hold the elastically deforming portion.

6. The vehicle seat according to claim 5, comprising:
a action portion provided in the elastically deforming portion and configured to contact the cable operation bracket to apply the elastic force to the cable operation bracket, the action portion having a linear shape and extending substantially parallel to the center axis; and
a restrictor provided on the cover member and configured to contact the action portion to restrict the action portion from tilting further when the action portion tilts beyond a specified range, wherein
the restrictor is out of alignment relative to the cable operation bracket in a direction of the center axis.
